(19) United States
(12) Patent Application Publication
(10) Pub. No.: US 2012/0076303 A1
(43) Pub. Date: Mar. 29, 2012

(54) INTERCEPT ACCESS POINT FOR COMMUNICATIONS WITHIN LOCAL BREAKOUTS

(75) Inventor: Edward A. O'Leary, Ajax (CA)

(73) Assignee: ROGERS COMMUNICATIONS INC., Toronto (CA)

(21) Appl. No.: 12/889,671

(22) Filed: Sep. 24, 2010

(51) Int. Cl. H04W 12/00; H04K 1/00; H04W 4/00

(52) U.S. Cl. 380/270; 455/422.1; 455/411

(57) ABSTRACT

Embodiments of the present disclosure provide for the capability within a gateway to dynamically monitor communications and protocols from a targeted user in a local breakout. A gateway product with this capability thus performs the function of an intercept access point (IAP). Communications to and from the targeted user are directed through the gateway and are intercepted in a manner not visible to the targeted user.

### TECHNICAL FIELD

The present application relates to lawful interception and, in particular, to devices and methods for gathering information regarding local breakout services.

### BACKGROUND

Lawful interception (LI) is a mandated requirement in many countries or jurisdictions that requires a Telecommunications Service Provider (TSP) to have the ability to monitor communications over the TSP's networks. This ability can, for example, provide law enforcement agencies with access to communications believed to be made for illegal purposes.

With the increase in local gateway products that provide local breakout functionality, such a femtocells and home gateways, communications may take place within the local network that are not visible to the TSP. Additionally, some TSPS are moving services that would normally be captured by LI requirements, such as IPTV (Internet Protocol Television), local telephony, and remote diagnostics, into such local breakouts, where LI is not traditionally required.

In an example, a femtocell allows normal wireless service, such a licensed cellular provided by a TSP, to terminate in a home and be carried back to the TSP over a broadband connection. Any service the user uses while on the cellular network can be captured by the TSP if it terminates in the TSP core network. Services provided within the femtocell do not terminate in the TSP core network and likely will not be captured. Current femtocell architectures do not provide access to capture any information from peer to peer communications within the respective femtocell.

In another example, home gateways (HGs) can be fully encompassed into an ISP (Internet Service Provider). Examples include DSL HGs (Digital Subscriber Line HGs) and Cable Modem HGs. The TSP provides remote monitoring and assistance service through the HG for an integrated home network environment. However, monitoring of peer to peer communications in such a home network environment can be detected by the user. For example, the user may notice modem activity caused by the monitoring activity or the monitoring activity may trigger a charge that shows on the user's ISP bill.

### SUMMARY

In one aspect, there is provided a method for intercepting peer to peer communications within a local network that is separated from a core network by a gateway, the method comprising: receiving, at an intercept access point located on the gateway, a command to intercept communications to and from a subject device operating within the local network; configuring a controller on the gateway to direct all communications to and from the subject device through the gateway; obtaining data from the communications to and from the subject device as the communications pass through the gateway; and storing the data in a memory on the gateway inaccessible by the subject device.

In another aspect, there is provided a gateway connecting a local network and a service provider core network, communications within the local network being independent of the core network, the gateway comprising: a receiver for receiving data related to the communications of a subject device within the local network; a memory for storing the data; an output for forwarding the data to a third party; and a controller configured to: cause the communications to and from the subject device to pass through the gateway; obtain the data from the communications of the subject as the communications pass through the gateway; store the data in the memory; and cause the output to forward the data to the third party.

In another aspect, there is provided a method for intercepting peer to peer communications within a local network that is separated from a core network by a gateway, the method comprising: receiving, at an intercept access point located on the gateway, a command to intercept communications to and from a subject device operating within the local network; configuring a controller on the gateway to direct all communications to and from the subject device through the gateway; obtaining data from the communications to and from the subject device as the communications pass through the gateway; and storing the data in a memory on the gateway inaccessible by the subject device.

### BRIEF DESCRIPTION OF THE DRAWINGS

FIG. 1 is a diagram of a system in which embodiments of the disclosure may be implemented.

FIG. 2 is a block diagram of a Femto cell on which embodiments of the present disclosure may be implemented;

FIG. 3 is a block diagram of a home gateway on which embodiments of the present disclosure may be implemented;

FIG. 4 is a block diagram of an Intercept Access Point (IAP) in accordance with one example embodiment of the present disclosure;

FIG. 5 is a block diagram of a gateway in accordance with one example embodiment of the present disclosure;

FIG. 6 is a block diagram of a gateway in accordance with one example embodiment of the present disclosure;

FIG. 7 is a block diagram of a gateway in use in accordance one example embodiment of the present disclosure;

FIG. 8A is a flowchart of a method in accordance with one example embodiment of the present disclosure; and

FIG. 8B is a flowchart of an embodiment of the method of FIG. 8A.

Like reference numerals are used in the drawings to denote like elements and features.

### DETAILED DESCRIPTION OF EXAMPLE EMBODIMENTS

Embodiments of the present disclosure provide for a capability within a gateway to dynamically monitor communications and protocols to and from a targeted user in a local breakout. A gateway with this capability thus performs the function of an intercept access point (TAP). The IAP function on the gateway can be implemented using physical or logic points. In some embodiments, the IAP is a separate module within a gateway. In other embodiments, the IAP functionality is integrated into gateway components.

For the purposes of this disclosure, local breakout includes any network where peer to peer communications are enabled without connecting to a TSP core network, such as but not limited to, networks provided by HGs and femtocells.

In some embodiments, the IAP includes a firewall and a bridging circuit that route peer to peer communications within the local breakout through the IAP. In this manner, the IAP can monitor communications and pass on information with respect to the monitored communications to the TSP or in some cases, directly to a law enforcement agency (LEA). In some embodiments, the IAP stores a copy of the communication in a memory on the IAP. In other embodiments, the IAP stores statistics related to the monitored communications, such as but not limited to a summary of Internet Protocol (IP) addresses and ports used and protocols used. Other information related to statistics that may be stored for lawful intercept is outlined in the Cable Broadband Intercept Specification (CBIS), CM-SP-CBI2.0-103-090121 Jan. 21, 2009.

The stored information can in some cases be accessed by a TSP or law enforcement agency. In other cases, the stored information is forwarded periodically or during a scheduled transmission. To meet the requirements of regulations related to LI, in some embodiments, the interception must be transparent to the subject of the interception. Therefore, the storing, accessing, and forwarding are masked in some embodiments. A non-limiting example of masking is to send the stored information concurrently with a scheduled transmission so that there is no unexplained activity at the gateway. In some embodiments, the intercepted data is separated and transmitted in small portions, so that the volume of data transmitted at any one time is not abnormal. This will reduce the likelihood that the target of the interception would suspect that intercepted data is being transmitted to the TSP or LEA. In another non-limiting example, the gateway includes a memory where the information related to the interception is stored, the memory being accessible only by the LEA or an administrator of the TSP. In some embodiments, a software firewall is used. This permits the data to be stored randomly in the memory, which in turn makes reading the memory difficult without proper authentication or authorization. In other embodiments, special abilities are required to open a device to access the memory. For example, special equipment may be needed to monitor memory elements or to decode microcode running on the gateway.

In some embodiments, the memory comprises a cache memory inside a microprocessor chip which is protected by a software firewall and only accessible by the LEA or an administrator of the TSP. In some example gateways, chips are used that are FPGA (Field program Gate Arrays) that also have internal memory that are not accessible by the subject of the interception. In still other embodiments, a custom chip is built with the IAP function fully enclosed in the chip, including the memory. In this case, there is no requirement for external memory.

In some embodiments, an external memory is used. In such cases, a file system can be used to delete a file in a manner that it is still on the memory but is not visible to the user. Alternatively, a routine hides pieces of the data all over the memory chip. In some embodiments, data that is required for the proper operation of the gateway is stored openly on the gateway, while the data required for LI purposes is hidden.

The accessing of the gateway for the purposes of LI can be masked in a variety of manners. In some embodiments, the gateway needs to communicate with the ISP network in order to do ARP (Address Resolution Protocol), DHCP (Dynamic Host Configuration Protocol) and other functions and these communications can be used to mask the LI. In embodiments where the gateway is a public hot spot, the ISP side of the internet is not visible to the end users, which comprise the subject of the LI. In embodiments where the gateway an integrated cable modem/DSL/router/WIFI in a home or local system, the ISP side is also not seen by the user. For consumer products, such as DlinK™, a number of network activities happen in the background and these activities can be used to mask the LI activity. Non-limiting examples of such network activities include an operating system checking for and installing updates, a virus scanner operating and looking for updates, and external devices looking for updates. In the case of a femtocell, non-limiting examples of network activities include reporting of frequency measurements to minimize network interference (for example in Self Organizing Networks (SON)), and reporting of user registration. Additionally all regular traffic and signalling traffic for any handset connected to the femtocell will be sent back over a VPN (Virtual Private Network) link. Because a femtocell is usually a managed device, it is possible to count how much traffic is off loaded for peer to peer activity, to look at address headers to help in future service calls and to remote access the gateway and configure it for the end user if they any connection issues.

Additionally, in some embodiments, measures are taken to ensure that transmissions related to the interception are accounted for separately so that the subject of the interception is not invoiced for those transmissions or statistics related to the transmissions are not disclosed to the subject. For example, data packets related to the interception can include an identifier in the header that will trigger a server at the TSP to redirect them accordingly and to omit them from the total size of the data transmission when reporting or accounting to the subject. Data packets related to the intercept are identified in some embodiments by sending them to designated IP address created for intercept purposes. Alternatively, the data packets can be part of management services and included as a dump of data including counters. An embodiment of the gateway uses packet switching features within the gateway to identify and capture traffic on a packet by packet basis. Non-limiting examples of packet switching include store and forward packet switching, cut-through packet switching and fragment-free packet switching which are explained in section 3.4 of http://services.eng.uts.edu.au/˜kumbes/ra/Switching/Packet-Switching/packet.html. The applications or modules that implement the packet switching features are programmed to be capable of capturing communications required for an LI such that the capturing can be evoked when required. In some embodiments, all the packets are temporarily copied to a memory and then packets that are not related to LI are discarded or deleted. In some embodiments, a dynamic routine is used to classify the data captured or stored. The data can be classified according to, but not limited to, Internet Protocol (IP) addresses, destination addresses, protocols used, the content of the data, or combinations thereof. In some embodiments, the data is classified before storing the data in the memory on the gateway. In some embodiments, the data is classified by the TSP after it is retrieved or transmitted.

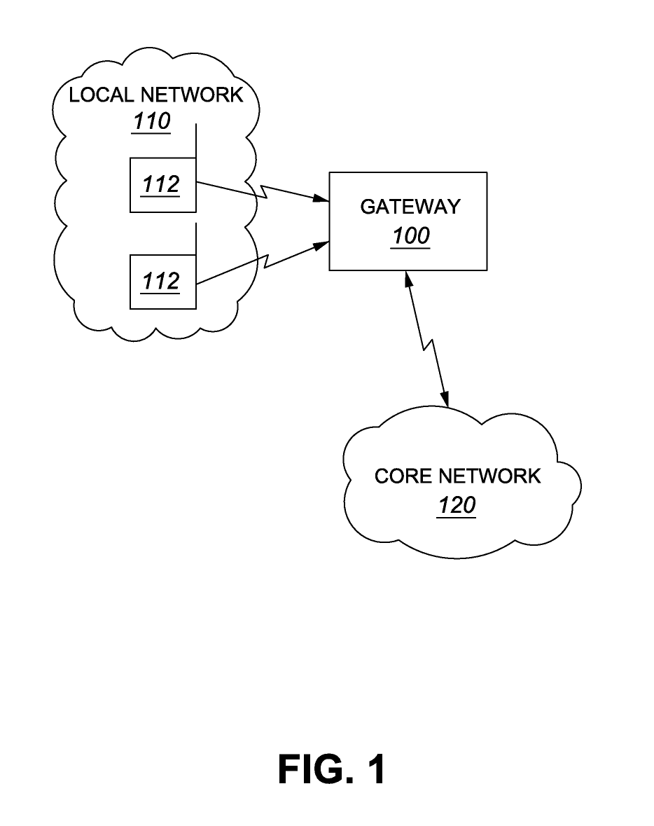

In use, embodiments of the present enclosure provide for lawful intercept of communications within a local network. Referring to FIG. 1, an example of an environment where the embodiments disclosed herein may be implemented will be described. A gateway 100 connects a local network 110 to a core network 120. Non-limiting examples of the local network 110 are a Local Area Network (LAN) 802.1, a WiFi (802.11) network, a Zigbee (802.15) network, or a local cellular network. Within the local network 110, devices 112 can communicate with each other through the gateway 100, for example using peer to peer communications. They may also communicate, in some embodiments, with devices outside the local network 110 through the gateway 100 and the core network 120. The core network 120 may be a part of a telecommunications service provider (TSP) network, an internet service provider (ISP) network or any other network providing communications or services from outside the local network.

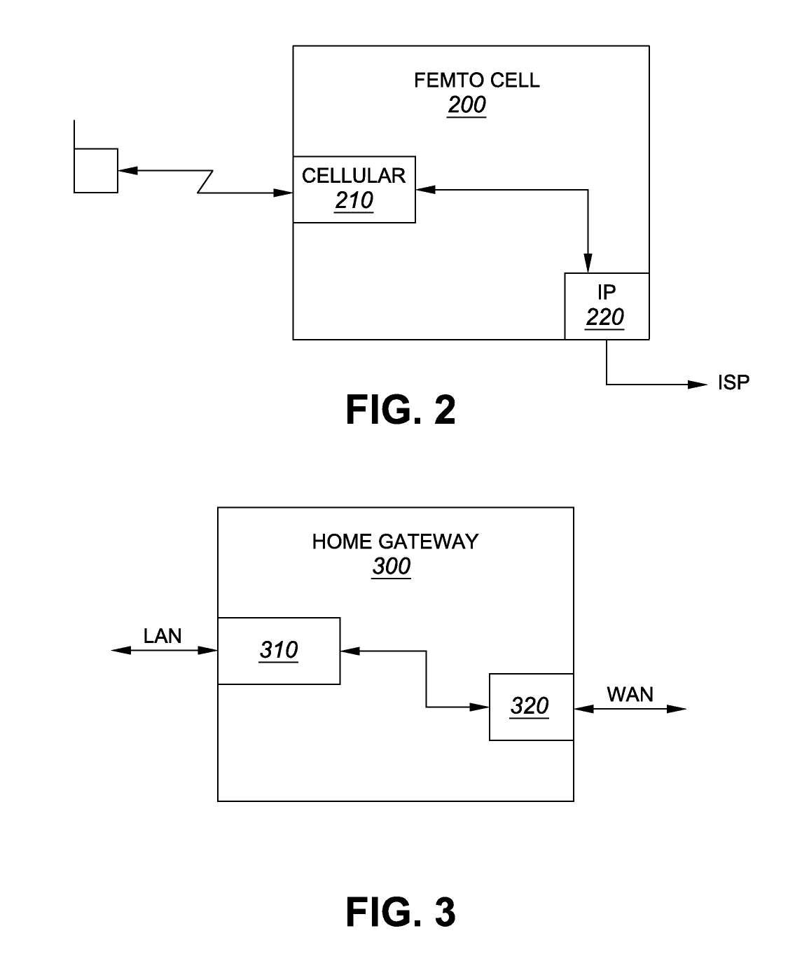

Examples of a gateway 100 include, but are not limited to, a home gateway and a femtocell. An exemplary femtocell 200, on which embodiments of the present disclosure may be implemented, will be described with reference to FIG. 2. The femtocell 200 comprises a cellular interface 210 for communicating with devices within the local network and an IP interface 220 for communicating with an ISP network. The cellular interface 210 and the IP interface 220 are connected. Femtocell 200 is described and depicted in a very general manner, as the embodiments described herein are not limited to any specific configuration of a femtocell. In some embodiments, the femtocell is a network managed device that uses licensed frequencies. A user may, in some cases, purchase a device from a retail outlet of the carrier on whose frequencies the device will operate. Each operator may configure their respective femtocells differently. When the femtocell is powered up and provided with an IP connection to the ISP or carrier, the femtocell will do several things: it will scan the frequencies of the licensed carrier; it will attempt to connect to the licensed carrier's network; and it will establish a secure link to the carrier network. Once connected, the femtocell: will validate a subscription; may do software updates; and will attempt to locate itself geographically. The location of the femtocell can be done in several ways, including but not limited to, using a scanned frequency list, information in the macro network that was scanned, IP tracing and GPS services, user subscription data, and data entered during the provisioning phase. The femtocell will provide the network with data it is collecting. This data can be used to provide an operating frequency to be used in the femtocell. A user cell phone will now see the femtocell frequencies and attempt to register on the femtocell. Pending configurations for closed services, an indication is required from the subscriber to accept the registration. This can be via SMS, web service, or local access to the femtocell administration function. Once set up, the user can transition seamlessly between femtocell and macro networks. Users who do not have access to the femtocell will stay on the macro network.

An exemplary home gateway 300, on which embodiments of the present disclosure may be implemented, will be described with reference to FIG. 3. The home gateway 300 comprises a LAN interface 310 for communicating with devices within the local network and a WAN (Wide Area Network) interface 320 for communicating with a WAN. The LAN interface 310 and the WAN interface 320 are connected. Home gateway 300 is described and depicted in a very general manner, as the embodiments described herein are not limited to any specific configuration of a home gateway. In some embodiments, the home gateway 300 is configured using a Web administration page. A user enters an IP address in a browser and provides credentials to access the administrator web page from which the gateway can be configured. Non-limiting examples of items that can be configured include: IP address ranges, counters, firewall rules, NAT (Network Address Translation) characteristics and DHCP (Dynamic Host Configuration Protocol) service. Clients on the LAN side are provided access to the WAN once the home gateway is configured. The access is based upon the rules established during configuration.

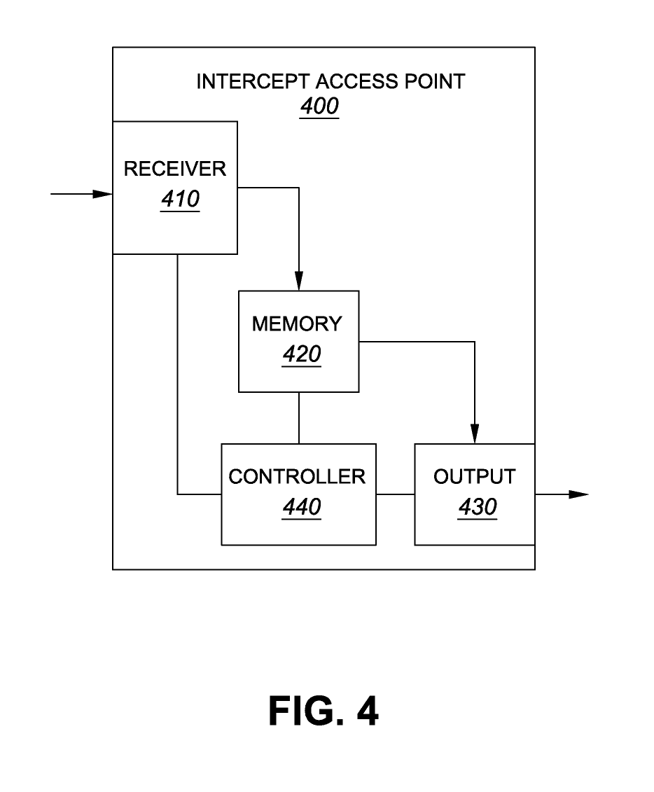

Now referring to FIG. 4, an intercept access point (IAP) 400 will be described. The IAP 400 is for implementation on a gateway connecting a local network and a service provider core network. Peer to peer communications within the local network are independent of the core network. The IAP comprises a receiver 410, a memory 420, an output 430 and a controller 440.

The receiver 410 is for receiving data related to the communications of a subject device within the local network. The data can be received over any form of communications link, such as but not limited to a cellular link, a wireless or wired LAN interface, and a wireless or wired IP interface. The memory 420 is for storing the data. In some embodiments, access to the memory is restricted to authorised entities. In some embodiments, the memory is not visible to the subject device. The memory 420, in some embodiments, is any non-volatile, tangible memory, including but not limited to shift registers.

The output 440 is for forwarding the data to a third party, such as a TSP administrator or a LEA. The output can be a broadband interface, an IP interface of any sort, or any other interface for communicating with the core network.

The controller 440 is configured to: cause the communications to and from the subject device to pass through the IAP 400; obtain the data from the communications to and from the subject device as the communications pass through the IAP 400; store the data in the memory 420; and cause the output 430 to forward the data to the third party. In some embodiments, the controller 440 is a separate processor. In other embodiments, the controller 440 is a functionality operating on a processor on the gateway. In some embodiments, the controller 440 is configured to cause the output 430 to forward the data concurrently with a scheduled transmission of other data. In some embodiments, the controller 440 is configured to apportion the data for output over a series of transmissions. In some embodiments, the controller 440 is configured to limit the amount of data that is output to a threshold maximum. In some embodiments, the controller 440 is configured to encrypt the data that is stored. In some embodiments, the controller 440 is configured to encrypt the data that is forwarded to the third party.

In some embodiments, the IAP 400 further comprises at least one of a firewall and a bridging circuit for redirecting the communications to and from the subject device through the IAP.

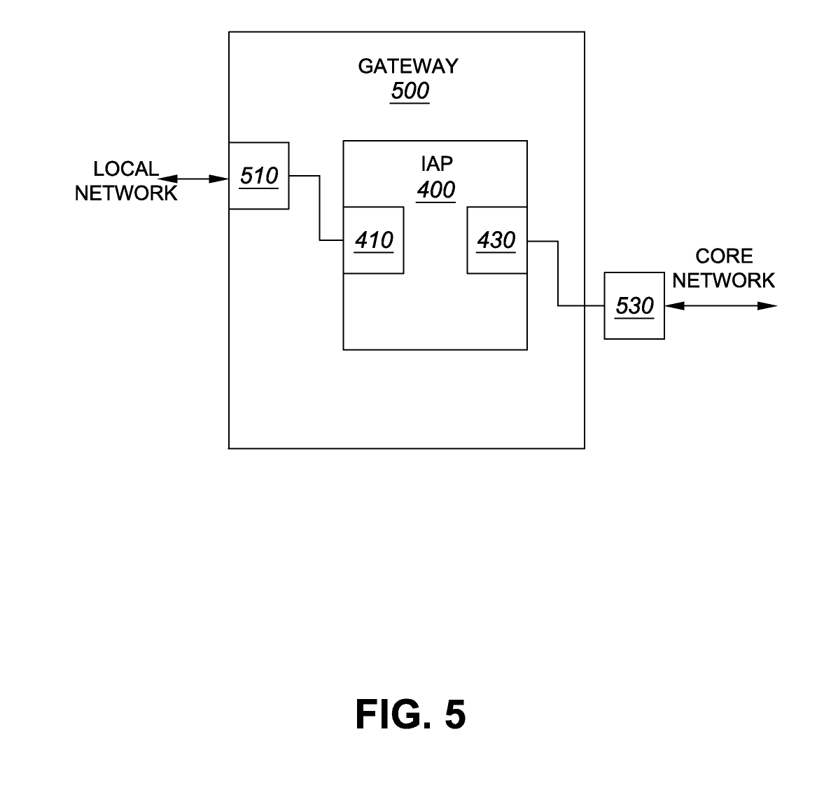

The IAP 400 is for implementation on a gateway. FIG. 5 shows an embodiment of a gateway 500 having the IAP 400 implemented thereon. The gateway 500 comprises a first interface 510 for communicating with the local network and a second interface 530 for communicating with the core network. The IAP 400 is connected to both interfaces 510 and 530. As mentioned above, in some implementations the IAP 400 is a separate module or functionality, as depicted in FIG. 5. However, it is to be understood that the functions of the IAP 400 can be integrated into the components of the gateway. For example the memory 420 can be part of a larger memory component of the gateway and the controller 440 can be implemented by a processor on the gateway.

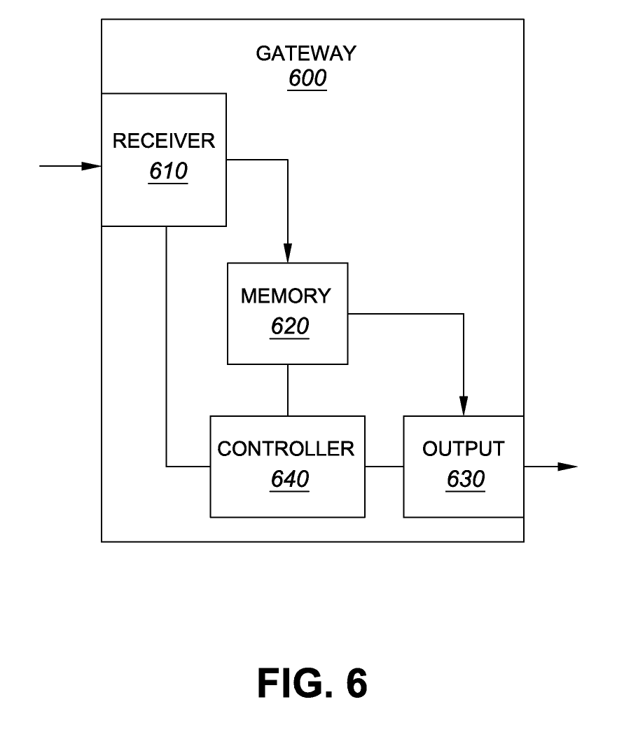

Referring now to FIG. 6, another embodiment of a gateway 600 will be described. The gateway 600 connects a local network and a service provider core network, communications within the local network being independent of the core network. The gateway comprises a receiver 610, a memory 620, an output 630 and a controller 640. The receiver 610 is similar to the receiver 410 of the IAP 400 and is for receiving data related to the communications of a subject device within the local network. The memory 620 is similar to the memory 420 of the IAP 400 and is for storing the data. The output 630 is similar to the output 430 of the IAP 400 and is for forwarding the data to a third party. The controller 640 is similar to the controller 440 of the IAP 400 and is configured to: cause the communications to and from the subject device to pass through the gateway 600; obtain the data from the communications of the subject as the communications pass through the gateway 600; store the data in the memory 620; and cause the output 630 to forward the data to the third party.

In some embodiments, the gateway 600 is a femto cell. In other embodiments, the gateway 600 is a home gateway or a residential gateway.

In some embodiments, the output 600 forwards the data over a broadband connection.

In some embodiments, the controller 640 uses packet switching features to identify and capture the data.

In some embodiments, the gateway 600 also includes an indicator that provides an indication of activity on the gateway. The indicator is configured to only indicate activity unrelated to the data obtained from the communications to and from the subject device. For example, the forwarding of the data to the third party would not cause the indicator to show any activity. In a non-limiting example, the indicator is an LED (Light Emitting Diode) that flashes when data not related to LI is being received at or output from the gateway 600.

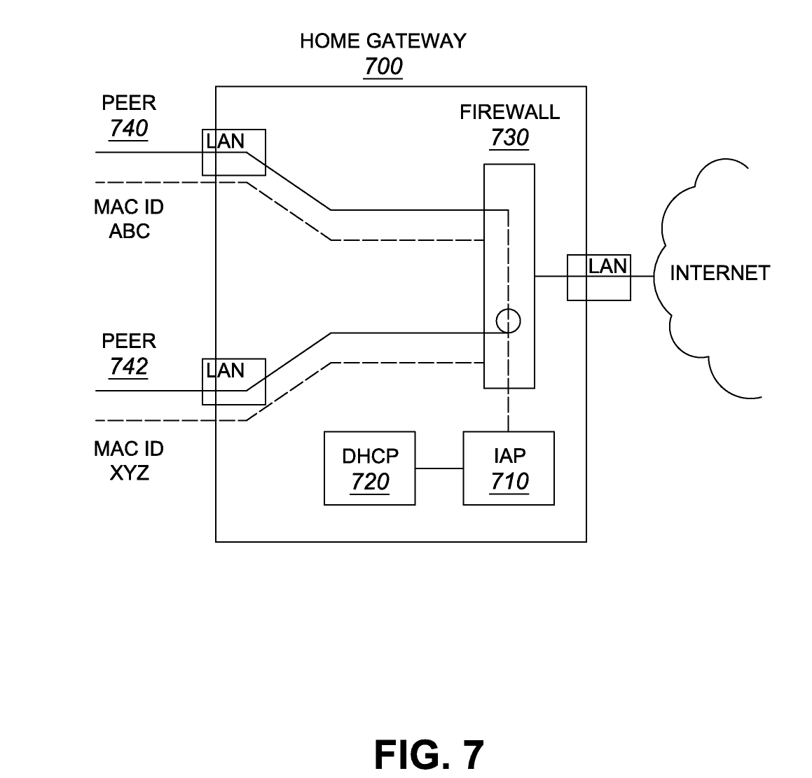

Referring now to FIG. 7, the operation of an example home gateway 700 will be described. An IAP 710 in the gateway 700 monitors a DHCP server 720 or monitors protocols on the bit level passing thru a firewall 730. In some embodiments, all functions on the home gateway 700 are executed in software, in which case software logic will copy packets of the target as it processes each packet. In some embodiments, some or all of the functions are implemented using hardware. In some embodiments, additional hardware is required monitor the IP packets. A MAC-ID or other String is used to capture the correct traffic. In cases where a peer 740 or 742 uses technology to spoof or send an erroneous MAC-ID, other user information and/or a key word that are used in the IP packets can be used to identify the IP address being used by the target. The IAP 710 will match these key words and strings against data in the packets. When a match occurs, the IAP will use this information to record or send copies of transmissions from the matched IP address. The IAP 710 will use other IP protocols to monitor changes in IP address of the target, like ARP (Address Resolution Protocol). If an IAP 710 is activated after the target of the LI, i.e. one of the peers 740 or 742, has gained an IP address, monitoring ARP will identify the Mac-ID and hence the desired target and it IP address. If spoofing has occurred, the IAP 710 will monitor for a key word as described above.

In FIG. 7, all IP traffic is routed to the firewall 730. The firewall 730 may utilize a NAT (Network Address Translator). The firewall 730 and other software act as a policy enforcement point, only allowing IP communication to authorized peers and IP addressed. Any peer to peer traffic (shown in dashed lines) will pass through the firewall 730. Monitoring can occur in several different locations within the firewall 730 based upon the design of the firewall.

Copies of packets with any IP address in the to or from headers for the target peer are copied into the IAP 710.

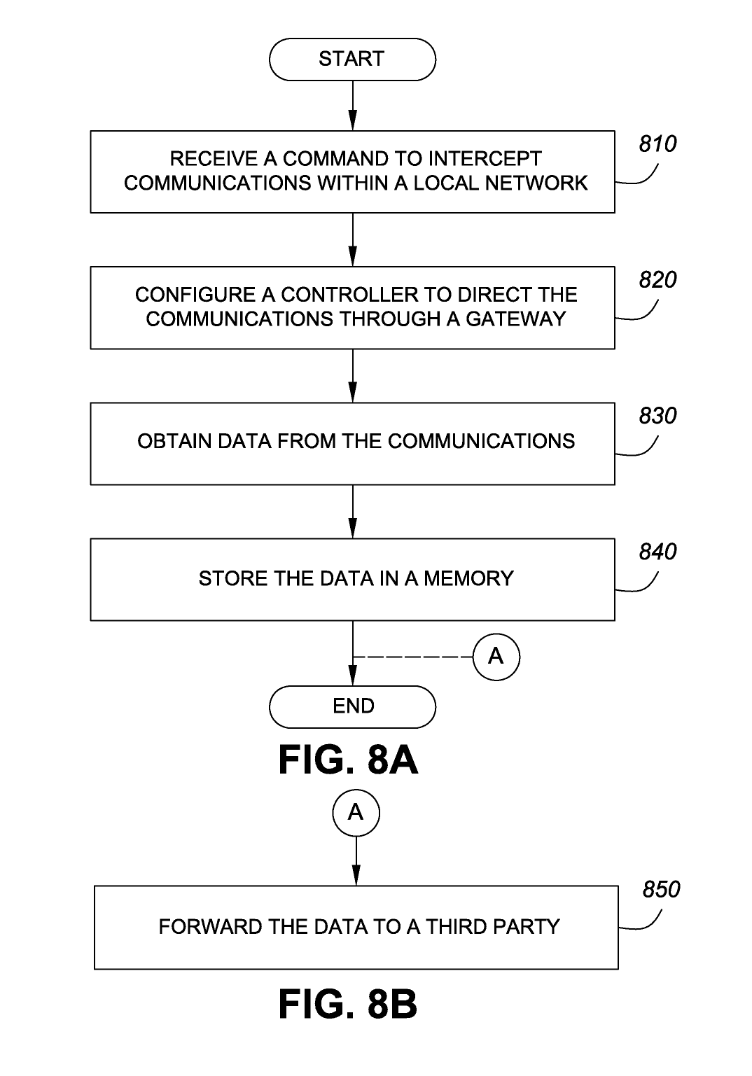

Referring now to FIGS. 8A and 8B, a method for intercepting peer to peer communications within a local network that is separated from a core network by a gateway will be described. At action 810, the method comprises receiving, at an intercept access point located on the gateway, a command to intercept communications to and from a subject device operating within the local network. Action 820 includes configuring a controller on the gateway to direct all communications to and from the subject device through the gateway. In some embodiments, this is done by using a firewall and a bridging circuit. Next at action 830, data is obtained from the communications to and from the subject device as the communications pass through the gateway. Then, at action 840, the data is stored in a memory on the gateway inaccessible by the subject device.

Referring to FIG. 8B, the method may include a further action 850 of forwarding the data to a third party. In some embodiments, the data is forwarded during a scheduled transmission. In some embodiments, the data is forwarded over a series of transmissions. In some embodiments, the data is forwarded over a series of scheduled transmissions.

In some embodiments, the method further comprises encrypting the data. This can involve encrypting the data before it is stored or encrypting the data before it is forwarded.

Embodiments disclosed herein allow for dynamic monitoring of ISP connections. In addition, intercepted traffic can be delivered covertly using a secure link to the TSP under conditions that the target of the interception would not suspect. The dynamic nature of the solutions disclosed herein allows the devices to evolve with changing requirements or changing regulations. It also allows for the devices to be customized for each client or jurisdiction.

It is to be understood that the actions of the methods are not limited to the order in which they are described are can be performed in any feasible order.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. An intercept access point (IAP) for a gateway connecting a local network and a service provider core network, peer to peer communications within the local network being independent of the core network, the intercept access point comprising:
a receiver for receiving data related to the communications to and from a subject device within the local network;
a memory for storing the data;
an output for forwarding the data to a third party; and
a controller configured to:
cause the communications to and from the subject device to pass through the IAP;
obtain the data from the communications to and from the subject device as the communications pass through the IAP;
store the data in the memory; and
cause the output to forward the data to the third party.

2. The IAP of claim 1, further comprising at least one of a firewall and a bridging circuit for redirecting the communications to and from the subject device through the IAP.

3. The IAP of claim 1, wherein the controller is configured to cause the output to forward the data concurrently with a scheduled transmission of other data.

4. The IAP of claim 1, wherein the controller is configured to apportion the data for output over a series of transmissions.

5. The TAP of claim 1, wherein the controller is configured to limit the amount of data that is output to a threshold maximum.

6. The TAP of claim 1, wherein access to the memory is restricted to authorised entities.

7. The TAP of claim 1, wherein the controller is configured to encrypt the data that is stored.

8. The TAP of claim 1, wherein the controller is configured to encrypt the data that is forwarded to the third party.

9. A gateway connecting a local network and a service provider core network, communications within the local network being independent of the core network, the gateway comprising:
a receiver for receiving data related to the communications of a subject device within the local network;
a memory for storing the data;
an output for forwarding the data to a third party; and
a controller configured to:
cause the communications to and from the subject device to pass through the gateway;
obtain the data from the communications of the subject as the communications pass through the gateway;
store the data in the memory; and
cause the output to forward the data to the third party.

10. The gateway of claim 9 comprising a femto cell.

11. The gateway of claim 9 comprising a home gateway.

12. The gateway of claim 9, wherein the output forwards the data over a broadband connection.

13. The gateway of claim 9, wherein the controller uses packet switching features to identify and capture the data.

14. The gateway of claim 9, further comprising an indicator that provides an indication of activity on the gateway, the indicator configured to only indicate activity unrelated to the data obtained from the communications to and from the subject device.

15. A method for intercepting peer to peer communications within a local network that is separated from a core network by a gateway, the method comprising:
receiving, at an intercept access point located on the gateway, a command to intercept communications to and from a subject device operating within the local network;
configuring a controller on the gateway to direct all communications to and from the subject device through the gateway;
obtaining data from the communications to and from the subject device as the communications pass through the gateway; and
storing the data in a memory on the gateway inaccessible by the subject device.

16. The method of claim 15, further comprising forwarding the data to a third party.

17. The method of claim 15, further comprising forwarding the data to a third party during a scheduled transmission.

18. The method of claim 15, further comprising forwarding the data to a third party over a series of transmissions.

19. The method of claim 15, further comprising forwarding the data to a third party over a series of scheduled transmissions.

20. The method of claim 15, further comprising encrypting the data.
